(19) United States
(12) Patent Application Publication
(10) Pub. No.: US 2023/0323620 A1
(43) Pub. Date: Oct. 12, 2023

(54) System for the cleaning and removal of oily and floating substances from rivers, channels and stream in general

(71) Applicant: Mold Srl, Cassola (VI) (IT)

(72) Inventor: Vanni Covolo, Cassola (VI) (IT)

(21) Appl. No.: 18/044,420

(22) PCT Filed: Sep. 17, 2020
(86) PCT No.: PCT/IB2020/058671

§ 371 Date: Mar. 8, 2023

(30) Foreign Application Priority Data
Sep. 11, 2020 (IT) 102020000021544

(51) Int. Cl. E02B 15/10; C02F 1/28; E02B 15/04

(52) U.S. Cl. CPC E02B 15/101; C02F 2103/007; E02B 15/045; C02F 1/285

(57) ABSTRACT

A system for cleaning rivers, channels and water courses in general includes floating modules, each having a cavity and an opening that puts the inside of the cavity in communication with the outer environment, and members that position the module so that the opening is at the height of the surface of a water body to be cleaned.

The present patent relates to devices for cleaning rivers and in particular concerns a new system for the cleaning of rivers and watercourses in general.

The problem relating to the pollution of watercourses and seas is well known and particularly relevant.

For example, on the surface of watercourses it is not unusual to find oil-based pollutants, discharged for example from drains or boats, which float given that they are lighter than water.

The accumulation of these floating substances on the surface of the water hinders the natural exchange of oxygen that normally occurs between a mass of water and the atmosphere, consequently impoverishing the quality of the water, particularly still water, to the detriment of fauna and aquatic flora.

The presence of these substances also limits or in any case influences the passage of sunlight, with the consequent harmful effects on aquatic flora and fauna.

One solution currently adopted involves conducting oil removal operations by means of individual devices which only have an effect in the vicinity of their installation site. For this reason, these devices must be continuously moved and in any case they cannot be effectively used in water courses where the current would quickly drag away part of the oils, further reducing the effectiveness of the reclamation operations.

To overcome all the aforementioned drawbacks a new system for cleaning rivers and watercourses in general was developed and constructed.

The main object of the present invention is to collect and extract substances floating on the surface of water, such as oils for example.

Another object of the present invention is not to interrupt the flow of the watercourse or prevent the normal navigation of vessels always enabling them to circulate, since the floating modules comprising the system in question move as a consequence of the thrust of the vessels themselves and/or can be selectively moved towards the banks of the watercourse in the event of the passage of large boats for example.

A further object of the present invention is to not disturb the ecosystem.

One advantage of the present invention is that it is modular and therefore adaptable to the size of the watercourse to be treated, which is furthermore treated across its entire width, thus maximizing the effectiveness of removal even in the presence of a current.

Another advantage of the present invention is that the modules can be produced in series, with a significant reduction of production costs.

Yet another important object is to simplify the system so as to reduce the construction and installation costs.

These and other direct and complementary objects are achieved by the new system for cleaning rivers and waterways in general, consisting in its main parts of one or more modules, where each module comprises one or more cavities communicating with the external environment, and means suited to position said module substantially at the height of the free surface of the water, so that the floating substances and oils enter and are collected inside said one or more cavities.

In one embodiment, said modules are for example made of or comprise at least one porous body, that is, provided with a plurality of said cavities, suitable for absorbing and therefore collecting the oils and floating substances. Said porous bodies can be replaced periodically, ensuring the effectiveness and continuity of the cleaning system. Said porous bodies can be kept on the free surface by means of floating and/or hollow elements and/or frames and positioning means in general.

In a preferred embodiment, said system comprises a plurality of said modules, each comprising at least one internally hollow part defining said at least one cavity having at least one opening communicating with the external environment, means for positioning said module so that said at least one opening is placed near or in correspondence with the free surface of the water. The module also comprises means for positioning said modules adjacent or next to each other along a line of any shape arranged substantially transversal to the body of water or to the channel, so as to involve at least in part or, preferably, the entire width of the watercourse.

In a first embodiment, each of said modules comprises a floating body, configured in such a way as to always remain positioned on the free surface of the water. This embodiment has the advantage of always ensuring the correct positioning of the module in the water, even in the presence of waves or tides.

In a second embodiment, said system comprises means suited to maintain said modules in correspondence with the free surface. This embodiment has the advantage of being able to selectively control the positions of the modules.

In a preferred embodiment, the inside of said cavity of the module, whether it be floating or non-floating, may contain an absorbent material, which retains the oily substances, and which can be periodically removed and replaced.

Said absorbent material can then be sent for subsequent disposal treatments.

Alternatively or in combination with said absorbent material, the interior of said cavity may communicate by means of at least one duct with a suction device which, periodically or continuously, extracts the oily substances collected in said cavity, transferring them to a collection point to be sent for subsequent disposal treatments.

In the floating solution, the system also comprises means for anchoring each of said modules to a fixed or mobile point.

According to one embodiment, said means for anchoring the modules are configured in such a way as to position several floating modules substantially along a line that crosses the watercourse transversely, and in such a way that said at least one opening is at least partially facing the direction from which the water flows, to facilitate the entry of floating substances.

Said floating modules are preferably anchored in such a way as not to rotate.

For example, said floating modules are anchored by means of flexible cables, so that they can be moved, for example, by large debris, such as tree trunks, or by boats, without preventing their passage.

In a further embodiment, said anchoring means comprise a frame to which said floating or non-floating modules are constrained, and wherein said frame is able to selectively slide laterally or comprises parts which slide laterally, towards the banks of the river, to correspondingly move said modules as well, thereby clearing the surface of the body of water when needed.

Said modules may have a generally three-dimensional, polyhedral and/or curved external shape.

The characteristics of the present invention will be better clarified by the following description with reference to the drawings, attached by way of a non-limiting example.

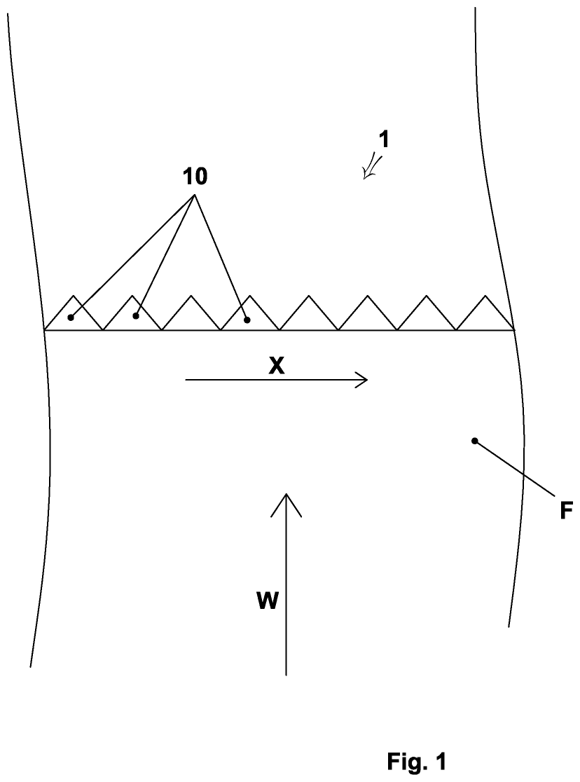

FIG. 1 shows a plan view of a possible arrangement of a plurality of modules (10) forming the system (1) for cleaning rivers, channels and waterways (F) in general.

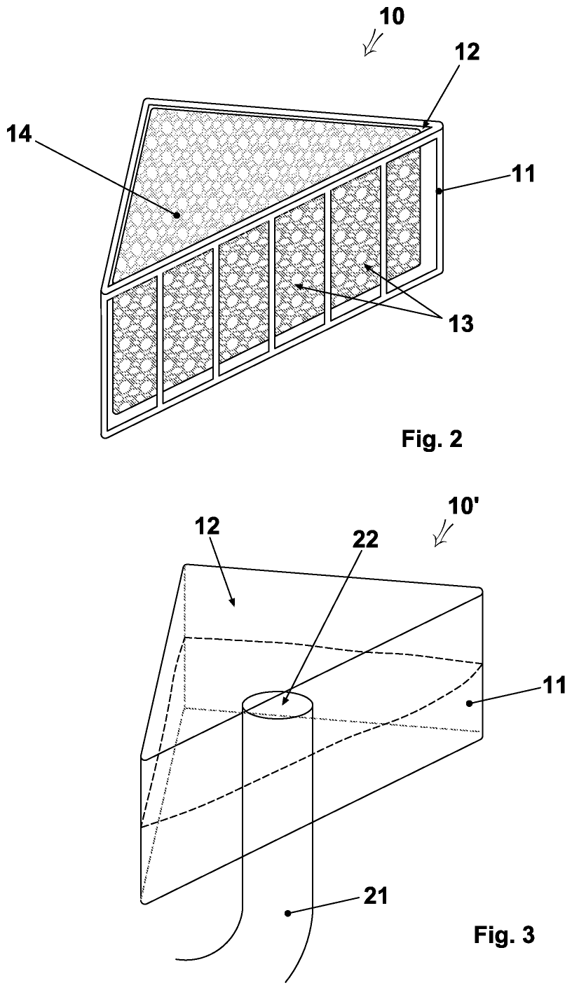

FIG. 2 shows a three-dimensional view of part of a module (10) in a preferred embodiment.

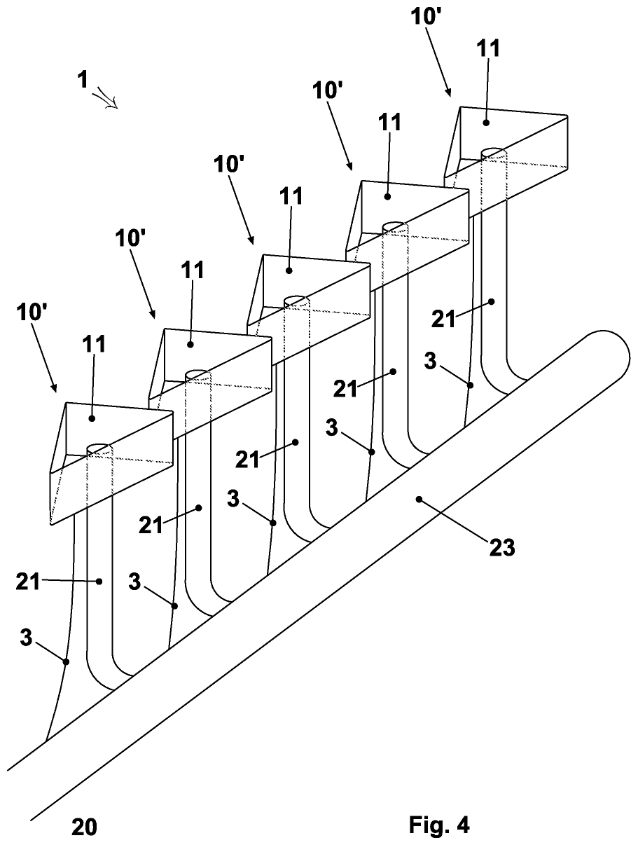

FIG. 3 shows a three-dimensional view of part of a module (10′) in an alternative embodiment.

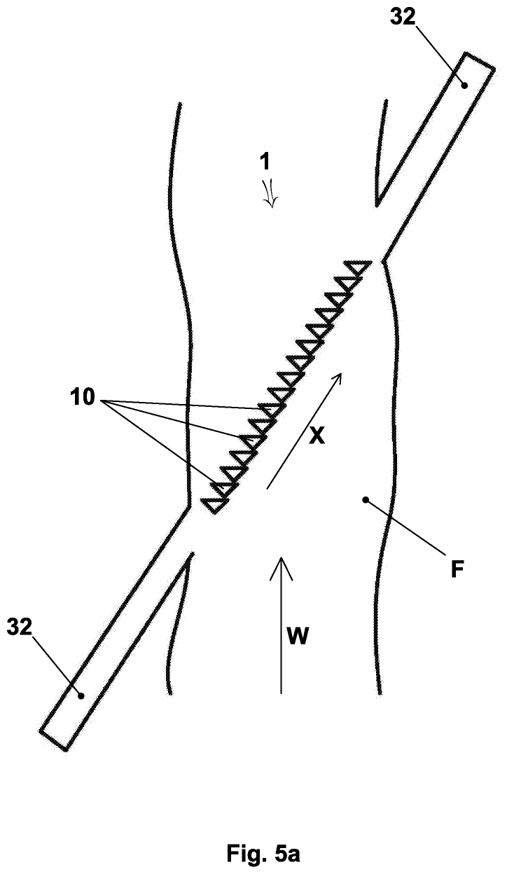

FIG. 4 shows a three-dimensional view of multiple modules (10′) as shown in FIG. 3 connected to a single oil collection manifold.

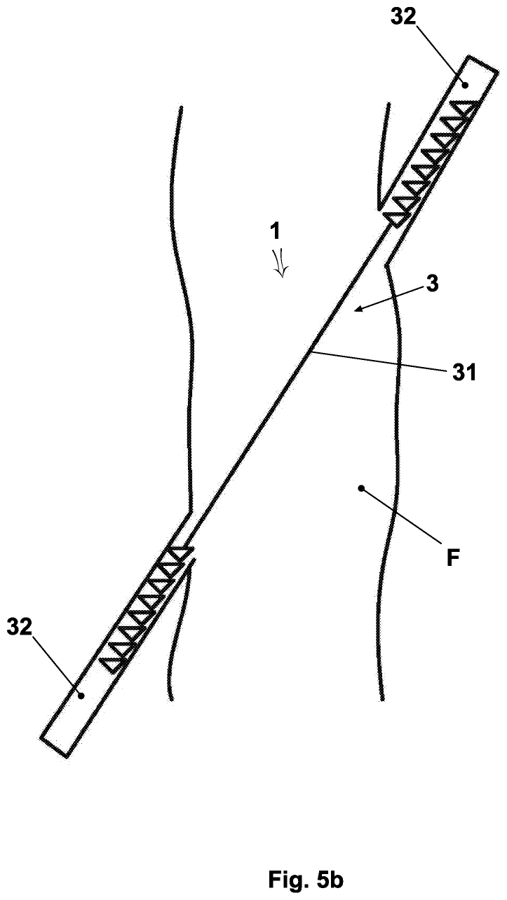

FIGS. 5a and 5b show a plan view of a possible arrangement of modules (10) and how these modules (10) may be moved sideways to completely clear the watercourse (F).

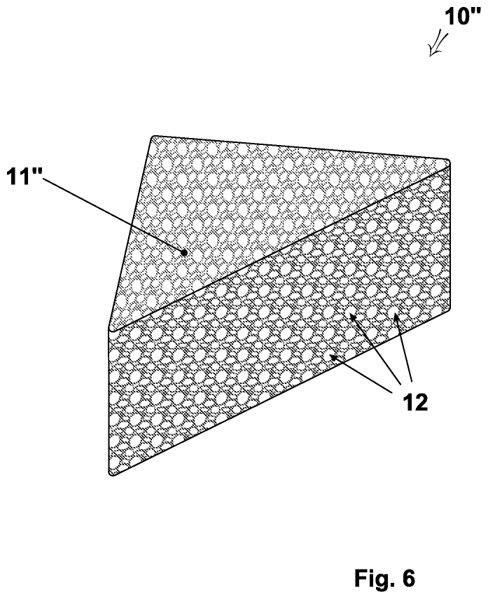

FIG. 6 shows a three-dimensional view of part of a module (10″) in an alternative embodiment.

The new system (1) for cleaning rivers and watercourses (F) in general is particularly and effectively usable in running watercourses.

The new system (1) includes one or more modules (10). FIGS. 2 and 3 show examples of two embodiments.

Each module (10) can have any shape, for example, but not necessarily, prismatic with a triangular base, as shown in the drawings.

Said module (10) in any case has a three-dimensional shaped body (11) with at least one internally hollow part which defines a cavity (12) intended to collect floating substances and oils on the free surface of the water.

For example, said cavity (12) coincides with the entire internal volume of the body (11) and is defined by the side walls of the body (11) itself.

Said cavity (12) comprises at least one opening (13) communicating with the environment outside the body (11), said opening (13) being for example made on one of the side walls of said body (11) of the module (10).

Said module (10) may float and said body (11) is therefore configured so that said at least one opening (13) is positioned substantially at the height of the free surface of the water, so that the floating substances and oils enter through said opening (13) and are collected inside said cavity (12).

Alternatively, said module (10) may not float, but is selectively constrained at the height of the surface of the water by positioning means or frames.

In the example shown in FIG. 2, said module (10) has substantially grid-like side walls, thus with many openings (13), and inside it there is a body made of absorbent material (14), that is, a body that absorbs and retains the floating and oily substances dragged along by the watercourse.

For example, said absorbent material is polypropylene.

Said body (14) made of absorbent material can be periodically removed and replaced.

In the embodiment shown in FIG. 3, the module (10′) comprises said at least one internal cavity (12), which, for example, substantially involves the entire volume of the body (11) of the module (10′) and is delimited by the lateral walls of the latter.

Said cavity (12) communicates with the environment outside of the body (11) by means of at least one opening (13) through which said floating and oily substances of the watercourse enter and are collected inside said cavity (12).

In the embodiment in FIG. 3, the module (10′) also comprises at least one duct (21) with a suction mouth (22) located inside said cavity (12) and connected to a suction device (20) which, periodically or continuously, extracts the oily substances collected in said cavity (12) of a module (10′) transferring them to a collection point to be sent for subsequent disposal treatments.

The system (1) may also comprise a single suction device (20) connected by means of one or more main manifolds (23) to said ducts (22) of all or part of said modules (10′).

In the embodiment with floating modules (10, 10′), said system (1) further comprises means (3) for anchoring said floating body (11) to a fixed or mobile point.

According to one embodiment, said anchoring means (3) of the modules (10, 10′) are configured in such a way as to position several such modules substantially along a line (X) which crosses the watercourse (F) transversely, that is, orthogonally to the direction (W) of the water flow (FIG. 1) or with any inclination with respect to that direction (W) (FIG. 5a).

For example, said anchoring means (3) are flexible cables, so that said modules (10, 10′) can be moved aside for example by large debris, such as tree trunks, or by boats, without preventing the passage of vessels in general.

In the embodiment in FIGS. 5a and 5b, which also applies to the embodiment with non-floating modules, said anchoring means (3) comprise a frame (31) to which said modules (10, 10′) are constrained, preferably by means of said flexible cables, and wherein said frame (31) can selectively slide laterally or comprises parts sliding laterally, towards the banks (F1) of the watercourse, to correspondingly move said floating bodies (11), thus clearing the watercourse when necessary.

As shown in FIGS. 5a and 5b, the system (1) may include guides or housing compartments (32) constructed beyond the banks (F1) of the watercourse (F), to house said modules (10, 10′) when they are moved sideways to completely clear the watercourse.

In the embodiment in FIG. 6, the module (10″) comprises a porous body (11″) having a plurality of said cavities (12) distributed and communicating with each other and with the outer environment to absorb and collect the floating oils and substances. The porous body (11″) may for example float and be held by a cable (3) and/or by a frame as previously described.

Therefore, with reference to the preceding description and the attached drawings the following claims are made.

1. A system for cleaning rivers and other watercourses, comprising:
one or more modules, wherein each module comprises one or more cavities in communication with an outer environment; and
means for positioning said one or more modules on a free water surface so that substances and oils floating on the water surface enter and are collected inside the one or more cavities.

2. The system according to claim 1, wherein one or more of said one or more modules comprises at least one internally hollow part defining one of said one or more cavities and at least one opening which puts an inside of said one or more cavities in communication with the outer environment, and wherein said means for positioning said one or more modules on the water surface are configured so that said at least one opening is located at a height of the water surface.

3. The system according to claim 1, wherein one or more of said one or more modules comprise a porous body having a plurality of said cavities communicating with each other and with the outer environment.

4. The system according to claim 1, wherein there are a plurality of said modules and positioning means for positioning said modules adjacent to each other along a line arranged transversely with respect to a watercourse.

5. The system according to claim 1, further comprising absorbent material contained in said one or more cavities of said one or more modules, and wherein said absorbent material absorbs and retains said floating substances and oils.

6. The system according to claim 5, wherein the system comprises a body made of said absorbent material contained in said one or more cavities, and wherein said body is removable from inside said one or more cavities.

7. The system according to claim 1, further comprising one or more ducts communicating with an interior of said one or more cavities of one or more of the one or more modules and with at least one suction device which, periodically or continuously, extracts said floating substances and oils collected in said one or more cavities.

8. The system according to claim 7, wherein said suction device is connected by one or more manifolds to said ducts.

9. The system according to claim 4, wherein one or more of said one or more modules comprises a floating body and means for anchoring said floating body to a fixed or mobile point.

10. The system according to claim 9, wherein said anchoring means comprise flexible cables.

11. The system according to claim 9, wherein said anchoring means or said positioning means comprise a frame to which said one or more modules are directly or indirectly connected, and wherein said frame can selectively slide laterally or comprises parts sliding laterally, towards banks of the watercourse, in order to correspondingly move all or some of said one or more modules.
